(19) United States
(12) Patent Application Publication
(10) Pub. No.: US 2005/0214476 A1
(43) Pub. Date: Sep. 29, 2005

(54) Protective coating composition

(76) Inventors: Andrew James Goodwin, Co Cork (IE); Merlin Patrick, Neufvilles (BE)

Correspondence Address: DOW CORNING CORPORATION CO1232, 2200 W. SALZBURG ROAD, P.O. BOX 994, MIDLAND, MI, 48686-0994, US

(21) Appl. No.: 10/509,710

(22) PCT Filed: Apr. 8, 2003
(86) PCT No.: PCT/EP03/04347

§ 371 Date: Sep. 30, 2004

(30) Foreign Application Priority Data
Apr. 10, 2002 (GB) 02082030

(51) Int. Cl. B05D 3/00; H05H 1/00

(52) U.S. Cl. 427/561; 427/569

(57) ABSTRACT

A method is disclosed for forming a polymeric coating on a substrate surface, which method comprises the steps of activating (A) at least one monomer selected from (a) at least one polymerizable organic acid monomer comprising at least one acid group and at least one polymerizable group and (b) at least one polymerizable organic acid anhydride monomer comprising at least one acid anhydride group and at least one polymerizable group and (B) at least one polymerizable organic base monomer comprising at least one basic group and at least one polymerizable group by subjecting the monomers to a soft ionization plasma process; and depositing the activated monomers resulting from step (i) onto the substrate surface thereby forming a polymeric coating containing salts resulting from interaction between acidic and basic functional groups on side chains of the polymeric coating. Preferred polymerizable groups are alkenyl groups. Polymeric salt coatings resulting from the above method have excellent barrier properties and coatings in accordance with the present invention will enhance the hydrophilic, biocompatible, anti-fouling and controlled surface pH applications of substrates such as filtration and separations media.

### CROSS-REFERENCES TO RELATED APPLICATIONS

This present application is a U.S. national stage filing under 35 USC 371 and claims priority from PCT Application No. PCT/EP 03/04347 entitled “PROTECTIVE COATING COMPOSITION” filed on Apr. 8, 2003, currently pending, which claims priority from Great Britain Patent Application 0208203.0 entitled “PROTECTIVE COATING COMPOSITION” filed on Apr. 10, 2002, currently pending.

### FIELD OF INVENTION

The present application describes a deposition process for coating substrates with a polymeric barrier coating utilizing plasma technology and particularly relates to the deposition of barrier coatings using at least one of polymerizable organic base monomers and polymerizable organic acid monomers which are polymerized to form a polymeric coating while maintaining their acidic or basic functionality.

### BACKGROUND OF THE INVENTION

The use of polymeric salt layers as dielectric films and biodegradable coatings have been proposed in EP 0547555 and EP 0396303 respectively. In EP 0547555 a polyimide ammonium salt reaction product of an ethylenically unsaturated amine with an aromatic polyimide having pendent carboxylic acid groups, in an organic solvent is used in combination with a cross-linker to coat substrates. In EP 0396303 a maleic acid co-polymer salt is utilized to improve biodegradability.

In EP 0376333 a process is described which utilizes plasma activated gaseous precursors and heat to produce a polyimide thin film coating on a substrate. The polyimide forming monomers are heated to produce monomer vapors which enter a vacuum radio frequency plasma and are then accelerated under vacuum by an electric field to condense upon the target substrate. The substrate must either be heated to a temperature in the region of about 200° C. during the coating stage or is heated to about 200° C. once the substrate is considered to be sufficiently coated with ionized polyimide forming monomers, to form a polyimide thin film on the substrate. In this cases polymerisation is affected through the reaction of acid anhydrides with diamines which results in the non-reversible formation of imide bonds to produce polyimide structures of the type shown below in formula (1). The free acid and free amine functionality of the precursors are irreversibly lost with the formation of the polyimide.

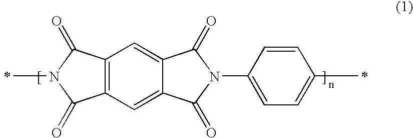

There is not the remotest suggestion in EP 0376333 that a polymer could be made while maintaining the acidic and basic functionalities of the polyimide forming monomers.

It is known that gas, flavor and aroma barrier coatings can be applied onto to substrates using acid and base precursors, as described for example in WO 98/31719 which describes the use of a composition comprising ethylenically unsaturated acids such as itaconic acid and a polyamine such as polyethylenimine together with a cross-linker such as a reactive silane. The resulting composition was applied onto a substrate in the form of a liquid coating and was then cured by means of a free radical reaction process initiated by electron beam radiation, gamma radiation, or ultra-violet radiation.

Substrates may be coated for a variety of reasons, for example to protect the substrate from corrosion, to provide a barrier to oxidation, to improve adhesion with other materials, to increase surface activity, and for reasons of biomedical compatibility of the substrate. A commonly used method for modifying or coating the surface of a substrate is to place the substrate within a reactor vessel and subject it to a plasma discharge. Many examples of such treatment are known in the art; for example, U.S. Pat. No. 5,876,753 discloses a process for attaching target materials to a solid surface which process includes affixing carbonaceous compounds to a surface by low power variable duty cycle pulsed plasma deposition, and EP 0896035 discloses a device having a substrate and a coating, wherein the coating is applied to the substrate by plasma polymerisation of a gas comprising at least one organic compound or monomer. WO 01/15764 describes a multi-step method for surface modification of a medical device involving a low temperature plasma treatment to provide a surface of the device with a plasma deposited layer which is then chemically treated with multifunctional linkers which are in turn reacted with bioactive/biocompatible agents. U.S. Pat. No. 5,723,219 describes a plasma deposited film network comprising a plurality of radio frequency discharge plasma film layers.

WO97/38801 describes a method for the molecular tailoring of surfaces which involves the plasma deposition step being employed to deposit coatings with reactive functional groups, which groups substantially retain their chemical activity on the surface of a solid substrate, using pulsed and continuous wave plasma. Wu et al. discuss in their related publication, Mat. Res. soc. Symp. Proc, vol. 544 pages 77 to 87 the comparison between pulsed and continuous wave plasma for such applications.

### DETAILED DESCRIPTION OF THE INVENTION

According to the present invention there is provided a method for forming a polymeric coating on a substrate surface, which method comprises the steps of
i. activating (A) a monomer selected from (a) at least one polymerizable organic acid monomer comprising at least one acid group and at least one polymerizable group and (b) at least one polymerizable organic acid anhydride monomer comprising at least one acid anhydride group and at least one polymerizable group, and (B) at least one polymerizable organic base monomer comprising at least one basic group and at least one polymerizable group, by subjecting the monomers to a soft ionization plasma process; and
ii. depositing the activated monomers resulting from step (i) onto the substrate surface thereby forming a polymeric coating containing salts resulting from interaction between acidic and basic functional groups on side chains of the polymeric coating.

The polymerizable groups on the monomers used in the method of the present invention must react under soft ionization plasma conditions to form a polymer. There must be a sufficient number of groups on each molecule for polymerisation to occur. Hence, therefore in the case of monomers such as acrylic acid one vinyl group is sufficient but in some cases, at least two polymerizable groups will be required per monomer for polymerization to occur.

Preferably, the polymerizable group of at least one of the polymerizable organic acid and acid anhydride and the polymerizable organic base are adapted to be reactable with each other to form polymers, while maintaining the acidic and basic groups intact as side chains on the polymer. The polymerizable organic acidic monomers are preferably also reactable with like polymerizable organic acidic monomers as well as the polymerizable organic base monomers and similarly the polymerizable organic base monomers are preferably also reactable with like polymerizable organic base monomers as well as the polymerizable organic acidic monomers. Hence, preferably the polymerizable organic base monomers and polymerizable organic acidic monomers will be randomly polymerized together, such that polymers containing solely acidic groups and polymers containing solely basic groups are unlikely to occur.

To obtain a coated substrate with a substantially random mix of acidic or basic group side chains, the polymerizable groups may all be the same i.e. they may all be alkenyl groups. In the case where a strictly ABABAB type polymer is required appropriate polymerizable groups may be selected such that the reactable groups on the acidic and polymerizable organic base monomers only react by a reaction pathway. Preferably, for example, each polymerizable groups may be an unsaturated hydrocarbon group such as a linear or branched alkenyl group or an alkynyl group or alternatively a polymerizable group such as alkoxy group, for example, methoxy, ethoxy, propoxy, isopropoxy groups or an —OH group or the like. The polymerizable groups are preferably unsaturated hydrocarbon groups and most preferably are alkenyl groups comprising from 2 to 10 carbon atoms such as a vinyl, propenyl, butenyl and hexenyl.

The polymerizable organic acidic monomers preferably comprise one or more carboxylic acid groups or an acid anhydride thereof or may comprise a sulphonic or phosphonic acid group. The polymerizable organic acidic monomers may be polybasic, or oligomers, polymers or copolymers of an unsaturated carboxylic acid or acid anhydrides. The polymerizable organic acidic monomers may also comprise short chain co-polymers of unsaturated carboxylic acids may be used with for example an appropriate unsaturated monomer such as ethylene, propylene, styrene, butadiene, acrylamide and acrylonitrile.

Hence, for example the polymerizable organic acidic monomers used in the method in accordance with the present invention may be selected from one or more of the following acrylic acid, alkylacrylic acid, fumaric, maleic, citraconic, cinnamic, itaconic acid monomethylester, vinylphosphonic acid, sorbic acid, mesaconic acid, and vinyl sulphonic acid itaconic acid, citric acid, succinic acid, ethylenediamine tetracetic acid (EDTA) and ascorbic acid.

The polymerizable organic acidic monomers may optionally contain one or more silicon atoms therein.

The polymerizable organic base monomers may comprise any suitable organic base having basic groups which will interact with the acid groups referred to above to reversibly form a salt. The polymerizable unsaturated organic base may optionally contain one or more silicon atoms therein and may be polyacidic or an oligomer, polymer or copolymer of a polymerizable organic base monomers. Preferably the polymerizable organic base monomers is a polymerizable primary or secondary amine. The polymerizable groups are preferably unsaturated hydrocarbon groups and most preferably are alkenyl groups comprising from 2 to 10 carbon atoms such as a vinyl, propenyl, butenyl and hexenyl. Most preferably the polymerizable organic base monomer is an unsaturated primary or secondary amine, such as for example 2-aminoethylene, 3-aminopropylene, 4-aminobutylene and 5-aminopentylene.

It is to be understood that a salt resulting from the method in accordance with the present invention is the product of the interaction between an acidic and a basic functional group. In the coatings produced from the method in accordance with the present invention, the acidic and basic functional groups will typically exist as polymer side chains. Salt formation as described herein is the well known reversible reaction of an acid and base as shown in formula (2) below, which results in a proton exchange from the acid to the base.
R—COOH+R′—NH₂ [symbol] R—COO⁻+R′—NH₃⁺ (2)

For example therefore, an organic unsaturated acid, H2C═CRCOOH and an organic unsaturated base, H₂C═CR′CH₂NH₂, may be reacted together under conditions of soft ionization to form a co-polymer with acidic and basic side chains of the type shown in formula (3) below. These polymers will typically be random copolymers, although block-wise copolymers may also be formed.

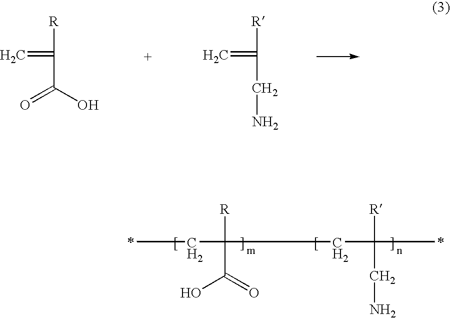

The acidic and basic group functionality is retained subsequent to polymerization and as such the resulting co-polymer depicted in formula (3) above will typically be present in accordance with the equilibrium formula (4) below:

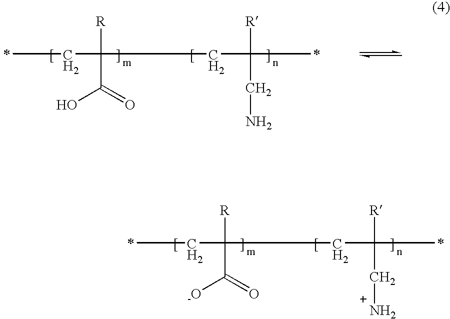

It will be seen from the example provided in support of the present invention below that, in air the coated substrate utilized had a coating in accordance with the present invention which largely had the disassociated structure on the right of formula (4) above and as such is described therein as a polymeric ammonium carboxylate salt film.

Indeed, it should be appreciated that the equilibrium will change in accordance with the pH environment in which the coated substrate is retained. One of the most important advantages of the present invention is that the resulting coating may be given a predetermined acid or basic nature, in that the proportions of acid and base introduced into the layer are such that the proportions can be determined based on the requirements for the application of interest to the user. Hence the substrate may be coated with any variation between a polymer resulting solely from the polymerizable organic base monomer or a polymer resulting solely from the polymerizable organic acidic monomer as required or determined by the user, such that a surface of a predetermined pH may easily be applied to the substrate surface by applying the acid and base in the required proportions which might for example be determined through at least one simple calculation and titration.

Optionally a further constituent may be co-reacted together with the at least one polymerizable organic base monomer and polymerizable organic acidic monomer in the method of the present invention. This further constituent is intended to function as a chain-extender or spacer (hereafter referred to as a “spacer”), and is adapted to react with the polymerizable groups of either or both the polymerizable organic base monomer and the polymerizable organic acid monomer so as to form part of the resulting polymer. The optional spacer may be any appropriate compound providing it is able to react with the at least two polymerizable groups of one or both of the monomers or with polymeric chains formed by the monomers during the method of the present invention. However, when the spacer is adapted to react with either the polymerizable group of the acid alone or the polymerizable group of the base alone it must be reactable with a minimum of two polymerizable groups of the polymerizable organic base monomer or a minimum of two groups of the polymerizable organic acidic monomer respectively.

Preferably the spacer is adapted to react with the polymerizable groups of both the polymerizable organic base monomer and the polymerizable organic acidic monomer. Preferably the spacer is an organic compound or a reactive organosilane. Preferably, when the polymerizable groups on the polymerizable organic basic monomers and polymerizable organic acidic monomers are unsaturated groups, the spacer comprises at one or more alkenyl groups and therefore may comprise one or more polymerizable alkenes such as ethene, propene, butene or the like or alternatively may comprise one or more dienes such as 1,3-butadiene, 1,4-pentadiene 1,5-hexadiene, 1,6-heptadiene and 1,7-octadiene and the like.

The substrate to be coated may comprise any material, for example metal, ceramic, plastics, siloxane, woven or non-woven fibres, natural fibres, synthetic fibres cellulosic material and powder but most preferably in the case of this invention the preferred substrate is a plastic material, for example thermoplastics such as polyolefins e.g. polyethylene, and polypropylene, polycarbonates, polyurethanes, polyvinylchloride, polyesters (for example polyalkylene terephthalates, particularly polyethylene terephthalate), polymethacrylates (for example polymethylmethacrylate and polymers of hydroxyethylmethacrylate), polyepoxides, polysulphones, polyphenylenes, polyetherketones, polyimides, polyamides, polystyrenes, phenolic, epoxy and melamine-formaldehyde resins, and blends and copolymers thereof. Preferred organic polymeric materials are polyolefins, in particular polyethylene and polypropylene.

The substrate may also be of the type described in the applicant's co-pending application WO 01/40359 wherein the substrate comprises a blend of an organic polymeric material and an organosilicon-containing additive which is substantially non-miscible with the organic polymeric material. The organic polymeric material may be any of those listed above, the organosilicon-containing additive is preferably linear or cyclic organopolysiloxanes. In the case of such substrates the organosilicon-containing additive migrates to the surface of the mixture and as such is available for reaction or where deemed necessary plasma or corona treatment. It is to be understood that the term “substantially non-miscible” means that the organosilicon-containing additive and the organic material have sufficiently different interaction parameters so as to be non-miscible in equilibrium conditions. This will typically, but not exclusively, be the case when the Solubility Parameters of the organosilicon-containing additive and the organic material differ by more than 0.5 MPa^{1/2}. The present invention has particular utility for coating plastics and films.

The form of plasma activation utilized may be any suitable type, provided it results in a “soft” ionization plasma process. It should be understood that a soft ionization process is a process wherein precursor molecules are not fragmented during the ionization process and as a consequence the resulting polymeric coating has the physical properties of the precursor or bulk polymer. Preferred processes are low temperature, cold plasmas such as low pressure pulsed plasma processing or atmospheric pressure glow discharge. Low temperature being below 200° C., and preferably below 100° C.

In the case of low pressure pulsed plasma, the acid and base are preferably introduced into the plasma in the form of vapours and polymerization initiated by the plasma. The low pressure pulsed plasma may be performed with at least one of substrate heating and pulsing of the plasma discharge. While for the present invention heating will not generally be required, the substrate may be heated to a temperature up to and below its melting point. Substrate heating and plasma treatment may be cyclic, i.e. the substrate is plasma treated with no heating, followed by heating with no plasma treatment, etc., or may be simultaneous, i.e. substrate heating and plasma treatment occur together. The plasma may be generated by any suitable means such as radio frequency, microwave or direct current (DC). A radio frequency generated plasma of 13.56 MHz is preferred. A particularly preferred plasma treatment process involves pulsing the plasma discharge at room temperature or where necessary with constant heating of the substrate. The plasma discharge is pulsed to have a particular “on” time and “off” time, such that a very low average power is applied, for example of less than 10 W and preferably less than 1 W. The on-time is typically from 10 μs to 10000 μs, preferably 10 μs to 1000 μs, and the off-time typically from 1000 μs to 10000 μs, preferably from 1000 μs to 5000 μs. The gaseous precursors may be introduced into the vacuum with no additional gases, however additional plasma gases such as helium or argon may also be utilized.

Any conventional means for generating an atmospheric pressure plasma glow discharge may be used in the method in accordance with the present invention, for example atmospheric pressure plasma jet, atmospheric pressure microwave glow discharge and atmospheric pressure glow discharge. Typically such means will employ a helium diluent and a high frequency (e.g. >1 kHz) power supply to generate a homogeneous glow discharge at atmospheric pressure via a Penning ionisation mechanism, (see for example, Kanazawa et al, J. Phys. D: Appl. Phys. 1988, 21, 838, Okazaki et al, Proc. Jpn. Symp. Plasma Chem. 1989, 2, 95, Kanazawa et al, Nuclear Instruments and Methods in Physical Research 1989, B37/38, 842, and Yokoyama et al., J. Phys. D: Appl. Phys. 1990, 2, 374). Examples of preferred apparatus are described in the applicant's co-pending applications WO 02/35576, which was published after the priority date of the present application, and GB 0208261.8. The plasma is formed using pairs of electrode units. Each electrode unit contains an electrode and an adjacent dielectric plate and a cooling liquid distribution system for directing a cooling conductive liquid onto the exterior of the electrode to cover a planar face of the electrode. Each electrode unit may comprise a watertight box having a side formed by a dielectric plate having bonded thereto on the interior of the box the planar electrode together with a liquid inlet and a liquid outlet. The liquid distribution system may comprise at least one of a cooler with a recirculation pump and a sparge pipe incorporating spray nozzles. The atmospheric pressure plasma assembly may also comprise a first and second pair of vertically arrayed parallel spaced-apart planar electrodes with at least one dielectric plate between said first pair, adjacent one electrode and at least one dielectric plate between said second pair adjacent one electrode, the spacing between the dielectric plate and the other dielectric plate or electrode of each of the first and second pairs of electrodes forming a first and second plasma region which assembly further comprises a means of transporting a substrate successively through said first and second plasma regions and is adapted such that said substrate may be subjected to a different plasma treatment in each plasma region.

It should be understood that the term vertical is intended to include substantially vertical and should not be restricted solely to electrodes positioned at 90 degrees to the horizontal.

For typical atmospheric pressure glow discharge plasma generating apparatus, the plasma is generated within a gap of from 3 mm to 50 mm, for example 5 mm to 25 mm. Thus, the method in accordance with the present invention has particular utility for coating films, fibers and powders when using atmospheric pressure glow discharge apparatus. The generation of steady-state glow discharge plasma at atmospheric pressure is preferably obtained between adjacent electrodes which may be spaced up to 5 cm apart, dependent on the process gas used. The electrodes being radio frequency energized with a root mean square (rms) potential of 1 kV to 100 kV, preferably between 4 kV and 30 kV at 1 kHz to 100 kHz, preferably at 15 kHz to 40 kHz. The voltage used to form the plasma will typically be between 2.5 kV and 30 kV, most preferably between 2.5 kV and 10 kV however the actual value will depend on the chemistry and gas choice and plasma region size between the electrodes. Each electrode may comprise any suitable geometry and construction. Metal electrodes may be used. The metal electrodes may be in the forms of plates or meshes bonded to the dielectric material either by adhesive or by some application of heat and fusion of the metal of the electrode to the dielectric material. Similarly, the electrode may be encapsulated within the dielectric material.

While the atmospheric pressure glow discharge assembly may operate at any suitable temperature, it preferably will operate at a temperature between room temperature (20° C.) and 70° C. and is typically utilized at a temperature in the region of 30° C. to 50° C.

When using an atmospheric pressure glow discharge system the at least one polymerizable organic base monomer and polymerizable organic acidic monomer may be introduced into an atmospheric pressure glow discharge plasma as a vapor by conventional means, or as an atomized liquid aerosol. The polymeric organic acid and base materials are preferably supplied to the relevant plasma region after having been atomised as described in the applicants co-pending patent application WO 02/28548, which was published after the priority date of the present application, i.e. using any conventional means, for example an ultrasonic nozzle. The atomizer preferably produces polymerisable monomers with drop sizes of from 10 μm to 100 μm, more preferably from 10 μm to 50 μm. Suitable atomizers for use in the present invention are ultrasonic nozzles from Sono-Tek Corporation, Milton, N.Y., USA. The apparatus of the present invention may include a plurality of atomizers, which may be of particular utility, for example, where the apparatus is to be used to form a copolymer coating on a substrate from two different coating-forming materials, where the monomers are immiscible or are in different phases, e.g. the first is a solid and the second is gaseous or liquid.

An advantage of using an atmospheric pressure glow discharge assembly for the plasma treating step of the present invention as compared with the prior art is that both liquid and solid atomized polymerizable organic base monomers and polymerizable organic acid monomers may be used to form substrate coatings, due to the method of the present invention taking place under conditions of atmospheric pressure. Furthermore at least one of the polymerizable organic base monomers and polymerizable organic acid monomers can be introduced into the plasma discharge or resulting stream in the absence of a carrier gas, i.e. they can be introduced directly by, for example, direct injection, whereby at least one of the polymerizable organic base monomers and polymerizable organic acid monomers are injected directly into the plasma.

The substrate may also be activated or pre-activated by the ionization plasma method described above for example step (ii) occurs either simultaneously with or immediately after step (i) and deposition may occur while the substrate is in the plasma activation region.

The process gas for use in either preferred plasma treatment of the method in accordance with the present invention may be any suitable gas but is preferably an inert gas or inert gas based mixture such as, for example helium, a mixture of helium and argon and an argon based mixture additionally containing at least one of ketones and related compounds. These process gases may be utilized alone or in combination with potentially reactive gases such as, for example, nitrogen, ammonia, O₂, H₂O, NO₂, air or hydrogen. Most preferably, the process gas will be Helium alone or in combination with an oxidizing or reducing gas. The selection of gas depends upon the plasma processes to be undertaken. When an oxidizing or reducing process gas is required, it will preferably be utilized in a mixture comprising 90%-99% noble gas and 1% to 10% oxidizing or reducing gas.

The duration of the plasma treatment will depend upon the particular substrate and application in question.

Preferably where the method of the present invention utilizes an atmospheric plasma glow discharge plasma assembly, the means of transporting a substrate is a reel to reel based process. Preferably in such a case the substrate may be coated on a continuous basis by being transported through an atmospheric plasma glow discharge by way of a reel to reel based process in which the substrate travels from a first reel, through the first plasma region at the end of which is provided a guide means or roller or the like adapted to direct substrate which has passed through the first plasma region into and through the second plasma region and on to a second reel at a constant speed to ensure that all the substrate has a predetermined residence time within the respective plasma regions. The residence time in each plasma region may be predetermined prior to coating and rather than varying the speed of the substrate the length of each of plasma region may be altered such that the substrate may pass through both regions at the same speed but may spend a different period of time in each due to the path length of the substrate through the respective plasma regions.

Optionally where required the substrate may be at least one of cleaned and activated prior to coating, using a helium or air plasma. Preferably at least one of the cleaning and activation steps will be carried out by subjecting the substrate to exposure to a plasma treatment.

Substrates coated by the deposition method of the present invention may have various utilities. In particular, it has been found that a polymeric salt coating produced in accordance with the above method has excellent barrier properties and coatings in accordance with the present invention will enhance the hydrophilic, biocompatible, anti-fouling and controlled surface pH applications of substrates. Controlled surface pH applications will include filtration (both gas and liquid) and separations media.

### EXAMPLES

The invention will be more clearly understood by reference to the following example with Reference to the figures in which:

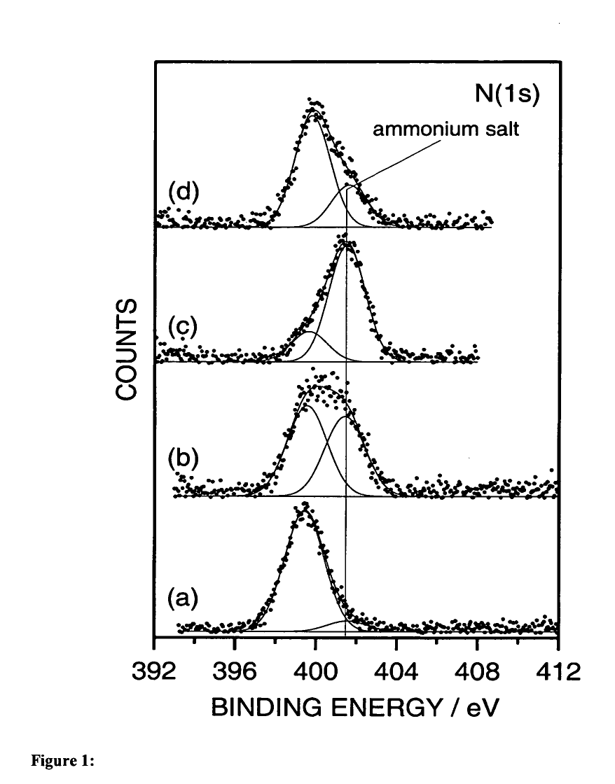

FIG. 1 shows a Quantification of ammonium salt formation using N(1s) XPS analysis

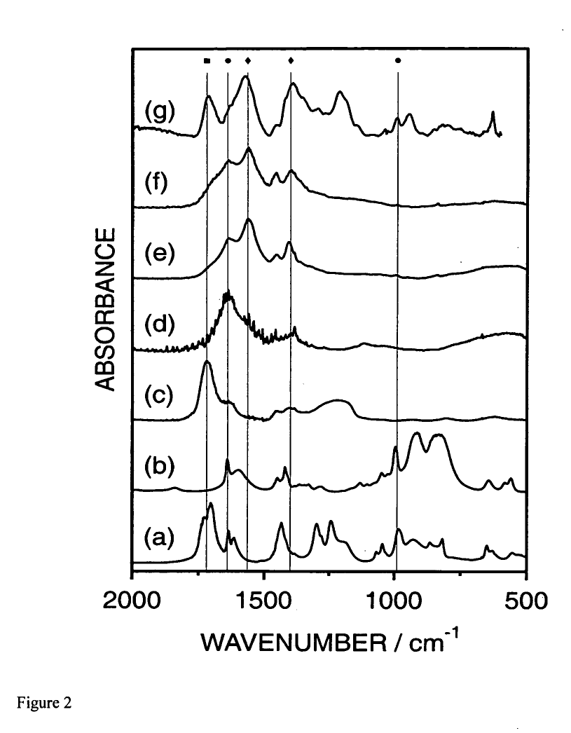

FIG. 2 shows Infrared spectra of Continuous wave and pulsed plasma depositions a variety of compositions

### EXAMPLE

### Polymeric Salt Coating by Low Pressure Pulsed Plasma

Acrylic acid (Aldrich, 99% purity) and allylamine (Aldrich, 99% purity) monomers were loaded into stoppered glass tubes, and further purified by multiple freeze-pump-thaw cycles. Pulsed plasma deposition of the individual monomers and also mixtures was carried out in a cylindrical glass reactor (418 cm³ volume) which was continuously pumped by a mechanical rotary pump via a liquid nitrogen cold trap (base pressure 8×10⁻³ mbar and 1.61×10⁻⁸ mol s⁻¹ leak rate). A copper coil wrapped around the reactor was coupled to a 13.56 MHz radio frequency (RF) power supply via an LC matching network. Prior to each experiment, the chamber was cleaned using a 50 W air plasma at 0.3 mbar. The respective monomer feeds were then introduced via fine control needle valves at a predetermined pressure. This was followed by ignition of the electrical discharge and film deposition. A signal generator was used to trigger the radio frequency (RF) supply, and the corresponding pulse waveform was monitored with an oscilloscope. The average power <P> delivered to the system was calculated using the following expression:
<P>=P_{P}{tₒₙ/(tₒₙ+t_{off})}
where P_{P} is the power output of the RF generator, tₒₙ and t_{off} are the pulse on- and off-periods respectively, and tₒₙ/(tₒₙ+t_{off}) is the duty cycle (see C. R. Savage, R. B Timmons, Chem. Mater. 1991, 3, 575). Typical conditions were 10 minutes deposition, with P_{P}=10 W, tₒₙ=100 μs and t_{off}=4000 μs. For comparative purposes, continuous wave plasma polymer films were deposited at 10 W. The notation used for describing plasma copolymerization follows the sequence in which the two monomers were introduced into the plasma chamber and their respective pressure settings. For example, AA_{0.2}AL_{0.1} corresponds to the introduction of 0.2 mbar acrylic acid vapour into the chamber, and then the opening up of allylamine to give a total pressure of 0.3 mbar (0.2 mbar+0.1 mbar), where 1 bar is 10⁵Nm⁻². The polymeric films were deposited onto glass slides (ultrasonically cleaned in a 1:1 solvent mixture of cyclohexane/propan-2-ol) for XPS analysis, potassium bromide powder for infrared analysis, and biaxial oriented polypropylene films (UCB) for gas permeation measurements.
XPS Analysis

A Kratos ES300 electron spectrometer equipped with a Mg Kα X-ray source (1253.6 eV), and a concentric hemispherical analyser was used for XPS analysis. Photo-emitted electrons were collected at a take-off angle of 30° from the substrate normal, with electron detection in the fixed retarding ratio (FRR, 22:1) mode. XPS spectra were accumulated on an interfaced PC computer and fitted using a Marquardt minimisation algorithm with Gaussian peaks all having the same full-width-at-half-maximum (FWHM). Instrument sensitivity factors using reference chemical standards were taken as C(1s):O(1s): Si(2p):N(1s) equals 1.00:0.57:0.72:0.74.

Continuous and pulsed plasma polymerisation of the individual and mixtures of acrylic acid and allylamine monomers were compared. In the case of salt formation, the different types of nitrogen environments were estimated by fitting the N(1s) XPS envelope: N—C(amine), N—C═O(amide) at 399.4-400.3 eV, and N(ammonium salt) at 401.4-401.7 eV in FIG. 1. The four plots in FIG. 1 represent the Quantification of ammonium salt formation using N(1 s) XPS analysis for the following:
(a) pulsed polyallylamine (AL_{0.3});
(b) pulsed plasma polymer−acrylic acid+allylamine (AA_{0.15}AL_{0.15});
(c) pulsed plasma polymer−acrylic acid+allylamine (AA_{0.2}AL_{0.1}); and
(d) continuous wave plasma polymer−acrylic acid+allylamine (AA_{0.2}AL_{0.1})

The small amount of ammonium salt detected in the case of the pure allylamine pulsed plasma deposited films can be attributed to post-treatment adsorption of atmospheric CO₂. Pulsed plasma polymerisation of AA_{0.2}AL_{0.1} monomer mixtures produced the largest amount of ammonium salt as seen in Table 1. The corresponding experiment using continuous wave plasma conditions produced films with markedly different chemical characteristics as seen in Table 1. The observed shift in N(1s) envelope towards lower XPS binding energies was consistent with the formation of less ammonium salt species.

TABLE 1
XPS elemental composition of pulsed plasma polymer films
(unless otherwise stated).

| | | | | % N | | |
|---|---|---|---|---|---|---|
| | | | | | | ammo- |
| | | | | | amine/ | nium |
| | % C ± | % Si ± | % O ± | Total ± | amide ± | salt ± |
| Monomer(s) | 3.0 | 0.1 | 3.7 | 0.6 | 0.4 | 0.6 |
| Acrylic acid | 63.2 | 0.0 | 36.8 | 0.0 | 0.0 | 0.0 |
| (AA) | | | | | | |
| Allylamine | 71.4 | 2.4 | 6.0 | 20.1 | 18.5 | 1.6 |
| (AL) | | | | | | |
| AA_{0.15}AL_{0.15} | 68.1 | 0.0 | 16.9 | 15.0 | 8.0 | 7.0 |
| AA_{0.2}AL_{0.1} | 66.9 | 0.0 | 23.3 | 9.8 | 2.5 | 7.3 |
| AA_{0.2}AL_{0.1} | 73.2 | 0.0 | 14.8 | 12.0 | 8.7 | 3.3 |
| (CW) | | | | | | |

Infra-Red Spectroscopy

Transmission infrared spectra were acquired over the 600-4000 cm⁻¹ wave number range at a resolution of 4 cm⁻¹ using a Mattson Polaris spectrometer. 100 scans were averaged in conjunction with background subtraction.

Infrared spectra obtained for the pulsed plasma polymer films of the individual monomers displayed strong similarities with those reported for the monomers used as shown in Table 2 and FIG. 2. The infrared spectra in FIG. 2 represent the following:—
(a) acrylic acid;
(b) allylamine;
(c) acrylic acid pulse plasma polymer;
(d) allylamine pulsed plasma polymer;
(e) pulsed plasma polymer−acrylic acid+allylamine (AA_{0.2}AL_{0.1});
(f) continuous wave plasma polymer−acrylic acid+allylamine (AA_{0.2}AL_{0.1}); and
(g) pure acrylic acid+allylamine liquid mixture (1:1 molar ratio).

For instance, in the case of pulsed plasma polymerised acrylic acid, the presence of a narrow absorption band at 1720 cm⁻¹ (C═O stretch) was indicative of high levels of carboxylic acid group retention. A broad peak at 1638 cm⁻¹ (N—H bend) was seen for pulsed plasma deposited allylamine films. The disappearance of alkene absorption bands at 1636-1642 cm⁻¹ (C═C stretch), 986-995 cm⁻¹ (trans CH=wag), and 912 cm⁻¹ (CH₂=wag) correlated to the opening of the carbon-carbon double bonds during plasma polymerisation of both monomers used.

CW and pulsed plasma deposition of AA_{0.2}AL_{0.1} mixtures gave a number of similar infrared features, FIG. 2. The carbon-carbon double bonds had reacted and the absorption band at 1705-1720 cm⁻¹ (C═O stretch) characteristic of carboxylic groups (as seen for acrylic acid) was absent. Instead two new carboxylate group (salt) peaks at 1562-1576 cm⁻¹ (asymmetrical CO₂) and 1391-1406 cm⁻¹ (symmetrical CO₂) were identified. For the pulsed plasma polymer films, these peaks were found to be more intense relative to the methylene band at 1454-1456 cm⁻¹ (thereby confirming the findings seen by XPS analysis). The infrared assignment for the carboxylate salt peak was confirmed by characterising a 1:1 liquid mixture of acrylic acid/allylamine.

TABLE 2
Assignment of infrared spectra.

| Wave number/ | | |
|---|---|---|
| cm⁻¹ | Assignment | Symbol |
| 1705-1720 | C═O stretching vibrations. | ▪ |
| 1599-1638 | N—H bending vibrations | |
| 1636-1638 | Amide I band. | |
| 1636-1642 | C═C stretching vibrations. | ● |
| 1638-1674 | C═N stretching vibrations. | |
| 1562-1576 | Asymmetrical CO₂⁻ stretching | ♦ |
| | vibrations. | |
| 1454-1456 | CH₂ bending vibrations. | |
| 1435 | C—O—H bending vibrations. | |
| 1391-1406 | Symmetrical CO₂⁻ stretching | ♦ |
| | vibrations. | |
| 1244-1300 | C—O stretching vibrations | |
| 986-995 | Trans CH═ wagging | ● |
| 912 | CH₂═ wagging | |
| 831 | NH₂ wagging | |

The polymer film growth rate was measured using a quartz crystal thickness monitor (Kronos, Inc Model QM-331) located in the centre of the plasma reactor.

Gas Barrier:

Gas permeation measurements were acquired using a mass spectrometry apparatus. This comprised placing a piece of coated polypropylene substrate between two drilled-out stainless steel flanges and a viton gasket. This assembly was attached to a UHV chamber via a gate valve (base pressure of 7×10⁻¹⁰ mbar) with the coated side of the polymer film exposed to an oxygen (BOC, 99.998%) pressure of 1316 mbar. A UHV ion gauge (Vacuum Generators, VIG 24) and a quadrupole mass spectrometer (Vacuum Generators SX200) interfaced to a PC computer were used to monitor the permeant pressure drop across the substrate. The quadrupole mass spectrometer's response per unit pressure was independently calculated by introducing oxygen directly into the chamber via a leak valve and recording the mass spectrum at a predetermined pressure of 5×10⁻⁷ mbar (taking into account ion-gauge sensitivity factors). This was then used to calculate mean equilibrium permeant partial pressure (MEPPP) of oxygen. Finally, the barrier improvement factor (BIF) for each sample was determined by referencing with respect to the MEPPP value measured for the uncoated polypropylene film.

Oxygen gas permeation measurements showed that pulsed plasma deposition using AA_{0.2}AL_{0.1} precursor mixtures gave rise to a ten-fold improvement in gas barrier, Table 3. Whereas the corresponding film prepared under continuous wave conditions produced no such improvement.

TABLE 3
Oxygen permeability measurements.

| | MEPPP | | Thickness | Deposition Rate | Total Treatment |
|---|---|---|---|---|---|
| Sample | (10⁻⁸) | BIF* | (nm) | (1 × 10⁻⁸ gs⁻¹) | Time (min) |
| o-PP (reference | 29.1 ± 1.3 | — | — | — | — |
| sample) | | | | | |
| pulsed deposited | 18.6 ± 5.4 | 1.6 | 101.9 ± 2.5 | 0.39 | 133 |
| allylamine | | | | | |
| pulsed deposited | 4.3 ± 2.7 | 6.8 | 253.4 ± 86.8^{†} | 2.53 | 10 |
| acrylic acid | | | | | |
| pulsed deposited | 2.9 ± 1.8 | 10.0 | 52.1 ± 1.1 | 2.91 | 10 |
| AA_{0.2}AL_{0.1} | | | | | |
| CW deposited | 21.4 ± 3.3 | 1.4 | 102.6 ± 4.0 | 4.34 | 5 |
| AA_{0.2}AL_{0.1} | | | | | |

*Barrier Improvement Factor
^{†}Variation may be attributed to water adsorption from the laboratory atmosphere.

Hence from the above it will be seen that the pulsed plasma co-polymerisation of acrylic acid with allylamine leads to the deposition of polymeric ammonium carboxylate salt films. These structurally well-defined layers exhibit high resistance to gas permeation.

1. A method for forming a polymeric coating on a substrate surface, which method comprises the steps of
i. activating (A) a monomer selected from (a) at least one polymerizable organic acid monomer comprising at least one acid group and at least one polymerizable group and (b) at least one polymerizable organic acid anhydride monomer comprising at least one anhydride group and at least one polymerizable group, and (B) at least one polymerizable organic base monomer comprising at least one basic group and at least one polymerizable group, by subjecting the monomers to a soft ionization plasma process; and
ii. depositing the activated monomers resulting from step (i) onto the substrate surface thereby forming a polymeric coating containing salts resulting from interaction between acidic and basic functional groups on side chains of the polymeric coating.

2. The method in accordance with claim 1 wherein the soft ionization plasma process is a low pressure pulsed plasma.

3. The method in accordance with claim 2 wherein the pulse on-time is from 10 to 1000 μs, and pulse off-time is from 1000 to 10000 μs.

4. The method in accordance with claim 1 wherein the soft ionization plasma process is an atmospheric pressure glow discharge.

5. The method in accordance with claim 1 wherein the polymerizable organic acid monomer is a polymerizable carboxylic acid.

6. The method in accordance with claim 5 wherein the polymerizable carboxylic acid is selected from at least one of acrylic acid, alkylacrylic acid, fumaric acid, maleic acid, citraconic acid, cinnamic acid, itaconic acid, sorbic acid and mesaconic acid.

7. The method in accordance with claim 1, wherein the organic base monomer is a polymerizable primary or secondary amine.

8. The method in accordance with claim 7 wherein the organic base monomer is selected from at least one of 2-aminoethylene, 3-aminopropylene, 4-aminobutylene, and 5-aminopentylene.

9. The method in accordance with claim 1, wherein the step of activating further comprises activating a spacer molecule.

10. The method in accordance with claim 9 wherein the spacer molecule is an alkene or diene.

11. The method in accordance with claim 1, wherein the substrate surface is activitated, or cleaned and activated using a plasma treatment before depositing the activated monomers.

12. The method in accordance with claim 2 wherein at least one of the polymerizable organic base monomer and the polymerizable organic acid monomer is introduced into the pulsed plasma in the form of a vapor.

13. The method in accordance with claim 4 wherein at least one of the polymerizable organic base monomer and the polymerizable organic acid monomer is introduced into the atmospheric pressure glow discharge in the form of an atomized liquid.

14. The method in accordance with claim 13 wherein the atomized liquid is produced using an ultrasonic nozzle.

15. A substrate having a deposited coating prepared according to the method of claim 1.

16. (canceled)
